(19) United States
(12) Patent Application Publication
(10) Pub. No.: US 2025/0379858 A1
(43) Pub. Date: Dec. 11, 2025

(54) SECURE ADDRESS DISCOVERY FOR SYMMETRIC NAT FUNCTIONALITY

(71) Applicant: Nokia Solutions and Networks Oy, Espoo (FI)

(72) Inventors: Keshavamurthi Jayanthi Murugesan, Tracy, CA (US); Rahul Singal, Cupertino, CA (US); Digvijay Khati, Fremont, CA (US); Lokheshvar Balakumar, Apex, NC (US)

(73) Assignee: Nokia Solutions and Networks Oy, Espoo (FI)

(21) Appl. No.: 18/734,438

(22) Filed: Jun. 5, 2024

(51) Int. Cl. H04L 9/40; H04L 12/46; H04L 43/12; H04L 45/74; H04L 61/2539

(52) U.S. Cl. CPC H04L 63/0435; H04L 12/4633; H04L 43/12; H04L 45/74; H04L 61/2539; H04L 12/4641

(57) ABSTRACT

In an enterprise having a local endpoint located behind a Symmetric NAT node, the local endpoint distributes its public IP address for endpoint packets to remote endpoints by generating probe packets having the local endpoint's private IP address as the source address in an outer IP header and the local endpoint's ID as the source address in an inner IP header. The Sym-NAT node replaces the private IP address with the public IP address for endpoint packets as the outer IP header's source address. Each remote endpoint uses the local endpoint's ID in the probe packet's inner IP header and uplink information from decrypted probe data to identify the source address in the probe packet's outer IP header as the local endpoint's public IP address for endpoint packets, thereby solving the problem of remote nodes receiving only the local endpoint's public IP address for controller packets from the enterprise controller.

### BACKGROUND

### Field of the Disclosure

The present disclosure relates to communication systems and, more specifically but not exclusively, to communication systems that support Network Address Translation (NAT) functionality.

### Description of the Related Art

This section introduces aspects that may help facilitate a better understanding of the disclosure. Accordingly, the statements of this section are to be read in this light and are not to be understood as admissions about what is prior art or what is not prior art.

A typical software-designed wide-area network (SD-WAN) enterprise has multiple SD-WAN endpoints, each of which is positioned at the customer edge facing an intervening network, such as the Internet, with fully meshed connectivity. Within such an enterprise, all endpoints function as peers, securely exchanging access clients' information through Internet Protocol Security (IPsec) tunnels. The dynamic authentication and exchange of keying materials between the endpoints for creating IPsec tunnels using the Internet Key Exchange version 2 (IKEv2) protocol can be a resource-intensive approach especially in full-mesh deployments. Instead, Group Domain of Interpretation (GDOI) may be efficient for global encryption key management.

In the GDOI design, a centralized GDOI controller is responsible for generating and distributing the keying materials, ensuring that all enterprise endpoints possess consistent access to the keying materials necessary for encrypting and decrypting their communications. The enterprise endpoints establish a control-plane connection (using protocols like OpenFlow, DTLS, etc.) with the controller.

Some or all of the endpoints may be deployed behind NAT nodes that perform a Network Address Translation (NAT) function to translate between (i) an endpoint's public IP address that is known to the Internet and (ii) the endpoint's private IP address that is not known to the Internet, but is known to the endpoint's private network that is deployed behind the same NAT node.

In particular, when a packet is to be transmitted from a local endpoint through the local endpoint's private network, then through the NAT node, and then through the Internet to a remote endpoint, the source address field in the packet generated by the local endpoint contains the local endpoint's private IP address. When that packet reaches and traverses the NAT node, the NAT node allocates a public IP address and then replaces the local endpoint's private IP address with that public IP address in the packet's source address field. As such, the packet can then be routed via the Internet to the remote endpoint.

Analogously, when a packet is transmitted from the remote endpoint to the local endpoint, the destination address field in the packet generated by the remote endpoint contains the NAT-allocated public IP address. As such, the packet can be routed via the Internet to the NAT node. When that packet traverses the NAT node, the NAT node replaces the public IP address with the local endpoint's private IP address in the packet's destination address field, which enables the packet to be routed from the NAT node through the private network to the local endpoint.

As part of bootstrapping, the endpoints establish control channels with the GDOI controller. The GDOI controller learns the NAT-translated public IP address, port number, and the associated private IP addresses and the port numbers of these endpoints from control-channel messages exchanged with the endpoints. The GDOI controller distributes this information to all other active endpoints in the enterprise.

Using this controller-provided information, the endpoints operate autonomously to create static IPsec tunnels within their local environments towards all the learned peer IP addresses and port numbers. These IPsec tunnels are established along with their associated Security Associations (SAs) that identify how to encrypt outgoing, unencrypted packets and decrypt incoming, encrypted packets. These SAs contain crucial parameters for unique SA identification such as the Security Parameter Index (SPI), Source IP, Destination IP, Source Port, and Destination Port. These parameters are essential for identifying and securing communication between endpoints.

Associated with each IPsec tunnel between two endpoints (A and B) are two SAs: (i) a first SA (AKA outbound SA) used to (1) encrypt unencrypted packets at endpoint A and (2) decrypt those encrypted packets at endpoint B and (ii) a second SA (AKA inbound SA) used to (1) encrypt packets at endpoint B and (2) decrypt those encrypted packets at endpoint A. Each endpoint maintains an SA database (SAD) containing each pair of SAs for each of its IPsec tunnels. Each endpoint uses a set of parameters to retrieve the appropriate SA from its SAD database. In particular, according to the Internet Engineering Task Force (IETF) RFC 4303 “IP Encapsulating Security Payload (ESP)” standard, the teachings of which are incorporated herein by reference in their entirety, in order to generate an outgoing encrypted packet, the transmitting endpoint uses the Source address and the Destination address to retrieve the appropriate SA from its SAD database to use to encrypt that packet. Similarly, according to that standard, the corresponding receiving endpoint uses the SPI, the Source address, and the Destination address extracted from the incoming encrypted packet to retrieve the appropriate SA from its SAD database to use to decrypt that packet.

There are different types of NAT functionality. According to the Symmetric NAT (Sym-NAT) function, an endpoint located behind a Sym-NAT node may be assigned (i) a first, unique combination of public IP address and port number (e.g., IP1:Port1) for packets sent between the endpoint and the GDOI controller and (ii) a different, unique combination of public IP address and port number (e.g., IP2:Port2) for packets sent between the endpoint and a remote, peer endpoint.

This introduces a significant complexity. The IPsec tunnels and Security Associations that were initially created in endpoints were based on the controller-distributed IP1:Port1 combinations might not be applicable for encrypting and decrypting data-path packets ingressing with the different IP2:Port2 combinations.

To resolve this, the endpoints have control channel communications between themselves to learn the IP2:Port2 combinations. As per IETF RFC 8489 standard, the teachings of which are incorporated herein by reference in their entirety, the Session Traversal Utilities for NAT (STUN) provides a tool for an endpoint to determine the public IP address and port allocated by a NAT node that corresponds to an endpoint's private IP address and port. The STUN tool also provides a way for an endpoint to keep a NAT binding alive. Since endpoints are connected via the unsecured Internet, the STUN technique to detect the NAT node has to be protected; otherwise, it is prone to security attacks. The STUN messages can be protected to some extent by performing Transport Layer Security (TLS) over User Datagram Protocol (UDP) or TLS over Transmission Control Protocol (TCP), but successful security attacks still occur.

### SUMMARY

Problems in the prior art are addressed in accordance with the principles of the present disclosure by a special mechanism for enterprise endpoints to discover their peer endpoints' NAT-translated IP addresses and port numbers in a secure way.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a block diagram of an example enterprise according to the disclosure;

FIGS. 2A-2C represent the prior-art NAT-Traversal tables maintained by the respective endpoints of FIG. 1;

FIG. 3 represents the format of a prior-art, encrypted, User Datagram Protocol (UDP) probe packet;

FIG. 4 is a block diagram illustrating the transmission of a special, encrypted, one-way, UDP probe packet;

FIGS. 5A-5C represent the updated NAT-Traversal tables at the respective endpoints of FIG. 1; and

FIG. 6 is a simplified hardware block diagram of an example node that can be used to implement elements of FIG. 1.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

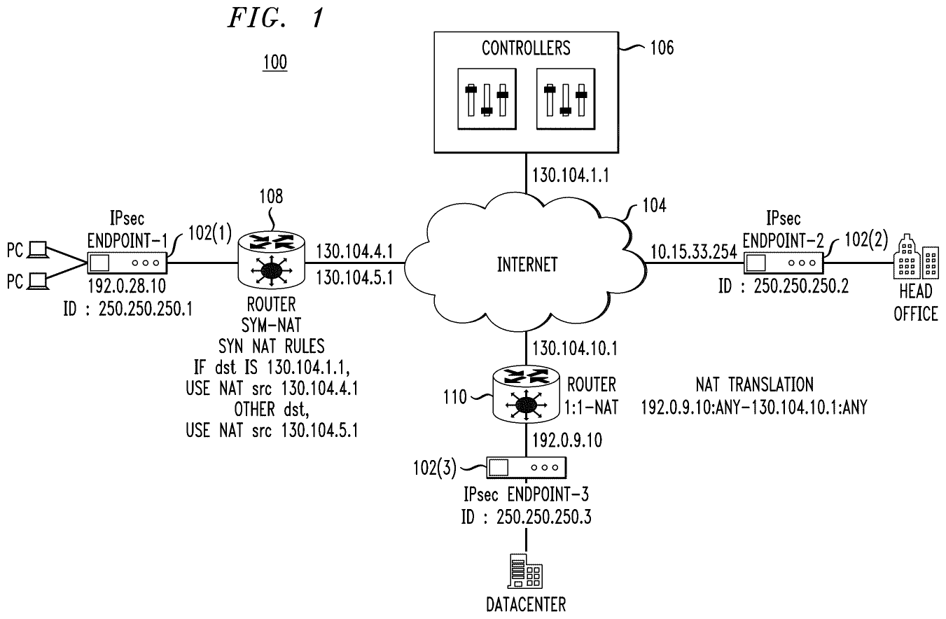

FIG. 1 is a block diagram of an example enterprise 100 according to the disclosure. As shown in FIG. 1, enterprise 100 has three IPsec endpoints 102(1)-102(3) and a GDOI controller 106 that communicate via the Internet 104, where endpoint 102(1) is located behind a Sym-NAT node 108 and endpoint 102 (3) is located behind a 1:1-NAT node 110. Those skilled in the art will understand that, in general, enterprises of the disclosure may have any suitable number of endpoints.

Because it is located behind Sym-NAT node 108, endpoint 102(1) has a private IP address (192.0.28.10) and two public IP addresses: one (130.104.4.1) for packets transmitted with the GDOI controller 106 and another (130.104.5.1) for packets transmitted with the other endpoints 102(2) and 102(3). Note that, because it is not located behind a NAT node, endpoint 102(2) has only a public IP address (10.15.33.254), while endpoint 102(3) has a private IP address (192.0.9.10) and only one public IP address (130.104.10.1), because endpoint 102(3) is located behind 1:1-NAT node 110. GDOI controller 106 also has only a public IP address (130.104.1.1).

As such, for a packet transmitted from endpoint 102(1) to the GDOI controller 106, the source Private IP address (192.0.28.10) of the endpoint 102(1) in the outgoing packet gets translated by Sym-NAT node 108 into public IP address (130.104.1.1). On the other hand, for a packet transmitted from endpoint 102(1) to either endpoint 102(2) or endpoint 102(3), the source Private IP address (192.0.28.10) of the endpoint 102(1) in the outgoing packet gets translated by Sym-NAT node 108 to a different Public IP address (130.104.5.1).

Analogously, for a packet transmitted from the GDOI controller 106 to endpoint 102(1), the destination Public IP address (130.104.4.1) in the incoming packet gets translated by Sym-NAT node 108 into endpoint 102(1)'s private IP address (192.0.28.10). On the other hand, for a packet transmitted from either endpoint 102(2) or endpoint 102(3) to endpoint 102(1), the destination Public IP address (130.104.5.1) in the incoming packet gets translated by Sym-NAT node into endpoint 102(1)'s private IP address (192.0.28.10).

In addition to public IP addresses and (possibly) private IP addresses, each endpoint 102 is also assigned (by the GDOI controller 106) a unique identifier (ID), which is a non-routable IP address from the reserved IP address space. This identifier is then distributed to all other active endpoints in the network. As such, each endpoint in the network is aware of the peer endpoint identifiers. In the example of FIG. 1, endpoint 102(1) has ID (250.250.250.1), endpoint 102(2) has ID (250.250.250.2), and endpoint 102(3) has ID (250.250.250.3).

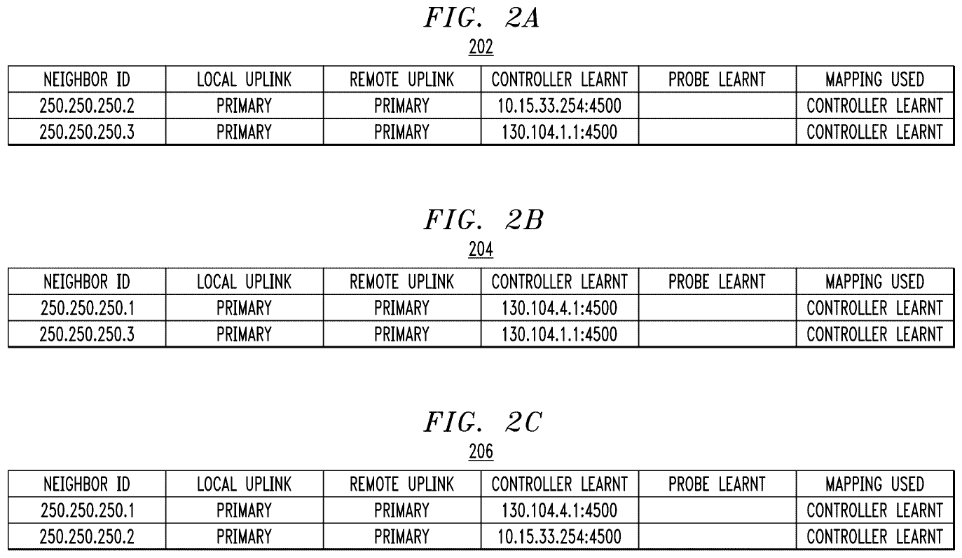

Every endpoint 102 maintains a NAT-Traversal table containing each other endpoint's information. For example, FIG. 2A represents the NAT-Traversal table 202 maintained by endpoint 102 (1) containing the following information for endpoints 102(2) and 102(3):
Neighbor ID—Identifier of peer endpoint
Local Uplink—Local uplink priority
Remote Uplink—Remote uplink priority.
Controller Learnt—Neighbor information learnt from the GDOI controller 106.
Probe learnt—Neighbor information learnt from probe messages sent by the other endpoints 102
Mapping Used—The used mapping, when there are both controller-learnt information and probe-learnt information

As shown in FIG. 2A, (i) the public IP address (10.15.33.254) and the port number (4500) for endpoint 102(2) having ID (250.250.250.2) and (ii) the public IP address (130.104.1.1) and the port number (4500) for endpoint 102(3) having ID (250.250.250.3) were all learnt by endpoint 102(1) via communications with the GDOI controller 106.

Each NAT node maintains an Inactivity timer for each IP address translation mapping in its memory, which timer gets reset whenever the corresponding translation is performed. If a timer expires, the corresponding mapping is deleted from the NAT node memory. In order to maintain the NAT node translation mappings, each endpoint 102 that is (i) located behind a NAT node or (ii) has an IPsec tunnel with another endpoint 102 that is behind a NAT node, periodically generates and transmits probe packets to each of its peer endpoints.

In particular, in every such endpoint 102, a Perfd generator generates probe packets with attributes such as source and destination uplink information, endpoint identifier, sequence number, etc. Perfd, which stands for “performance daemon”, is a Linux process that has real-time access to system performance. The Perfd generator also constructs packet metadata with source and destination uplink information which is used later in the pipeline for forwarding. In addition, in every such endpoint 102, a Perfd analyzer analyzes received probe packets and updates the NAT-Traversal table's “Probe-learnt” section.

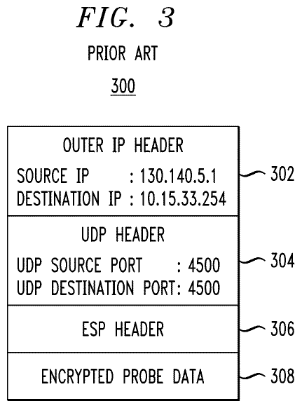

FIG. 3 represents the format of a prior-art, encrypted, User Datagram Protocol (UDP) probe packet 300 transmitted through the Internet 104 from endpoint 102(1) to endpoint 102(2), where:
Outer IP Header 302 contains endpoint 102(1)'s public IP address (130.140.5.1) for endpoint packets as the source address and endpoint 102(2)'s public IP address (10.15.33.254) as the destination address;
UDP Header 304 contains the standard value (4500) for the source and destination ports for encrypted packets;
Encapsulating Security Payload (ESP) Header 306; and
Encrypted Probe Data 308 containing attributes such as source and destination uplink information, endpoint identifier, sequence number, etc.

The attributes are encrypted to form the Encrypted Probe Data 308.

Assume a situation in which enterprise 100 already has endpoints 102(2) and 102(3) up and running when endpoint 102(1) is initially powered on. In that scenario, endpoint 102(1) initially connects to the GDOI controller 106 via the Sym-NAT node 108 using the controller's public IP address (130.104.1.1), where the Sym-NAT node 108 translates the source address in endpoint 102(1)'s packet from endpoint 102(1)'s private IP address (192.0.28.1) to public IP address (130.104.4.1) for controller packets.

In response, endpoint 102(1) learns the following information from the GDOI controller 106:
Endpoint 102(1)'s own identifier (ID 250.250.250.1) · Neighbor information for endpoints 102(2) and 102(3), which endpoint 102(1) uses to update the Controller-learnt section of its NAT-Traversal table 202, as shown in FIG. 2A. The keying materials for creating IPsec tunnels and Security Associations with endpoints 102(2) and 102(3)

In addition, the GDOI controller 106 learns endpoint 102(1)'s information such as its NAT-translated public IP address (130.104.4.1) for controller packets. The GDOI controller 106 distributes endpoint 102(1)'s information to endpoints 102(2) and 102(3), which accordingly update the Controller-learnt sections of their NAT-Traversal tables 204 and 206, as shown in FIGS. 2B and 2C, respectively.

With this information, all of the endpoints 102 compute the inbound and outbound SAs locally and create IPsec tunnels with their peer endpoints using the IP addresses and neighbor IDs in their NAT-Traversal tables. In particular, endpoint 102(1) will have the following IPsec tunnels with endpoints 102(2) and 102(3):
Endpoint 102(1) (192.0.28.10:4500)-Endpoint 102(2) (10.15.33.254:4500)
Endpoint 102(1) (192.0.28.10:4500)-Endpoint 102(3) (130.104.10.1:4500)
Endpoint 102(1) (250.250.250.1:4500)-Endpoint 102(2) (250.250.250.2:4500)
Endpoint 102(1) (250.250.250.1:4500)-Endpoint 102(3) (250.250.250.3:4500)

Similarly, endpoint 102(2) will have the following IPsec tunnels with endpoints 102(1) and 102(3):
Endpoint 102(2) (10.15.33.254:4500)-Endpoint 102(1) (130.104.4.1:4500)
Endpoint 102(2) (10.15.33.254:4500)-Endpoint 102(3) (130.104.10.1:4500
Endpoint 102(2) (250.250.250.2:4500)-Endpoint 102(1) (250.250.250.1:4500)
Endpoint 102(2) (250.250.250.2:4500)-Endpoint 102(3) (250.250.250.3:4500)

Likewise, endpoint 102(3) will have the following IPsec tunnels with endpoints 102(1) and 102(2):
Endpoint 102(3) (192.0.9.10:4500)-Endpoint 102(1) (130.104.4.1:4500)
Endpoint 102(3) (192.0.9.10:4500)-Endpoint 102(2) (10.15.33.254.1:4500)
Endpoint 102(3) (250.250.250.3:4500)-Endpoint 102(1) (250.250.250.1:4500)
Endpoint 102(3) (250.250.250.3:4500)-Endpoint 102(2) (250.250.250.2:4500)

Note that, for example, endpoint 102(1) creates an IPsec tunnel with endpoint 102(2) using endpoint 102(1)'s private IP address (192.0.28.10), while endpoint 102(2) creates an IPsec tunnel with endpoint 102(1) using endpoint 102(1)'s public IP address (130.104.4.1) learned from the GDOI controller 106. Similarly, endpoint 102(1) creates an IPsec tunnel with endpoint 102(3) using endpoint 102(1)'s private IP address (192.0.28.10) and endpoint 102(3)'s public IP address (130.104.10.1) that endpoint 102(1) learned from the GDOI controller 106, while endpoint 102(3) creates an IPsec tunnel with endpoint 102(1) using endpoint 102(3)'s private IP address (192.0.9.10) and endpoint 102(1)'s public IP address (130.104.4.1) learned from the GDOI controller 106.

The problem is that, when endpoint 102(1) tries to transmit a packet to either endpoint 102(2) or endpoint 102(3), the Sym-NAT node 108 will use its other destination rule and translate the source address in the packet from endpoint 102(1)'s private IP address (192.0.28.10) to public IP address (130.104.5.1). Unfortunately, neither endpoint 102(2) nor endpoint 102(3) will be able to recognize the received packet because they are only aware of endpoint 102(1)'s public IP address for controller packets (130.104.4.1) that they learned from the GDOI controller 106; they are not aware of endpoint 102(1)'s public IP address for endpoint packets (130.104.5.1). To address this problem, endpoint 102(1) generates and transmits special, encrypted, one-way, UDP probe packets to distribute endpoint 102(1)'s public IP address for endpoint packets to endpoints 102(2) and 102(3).

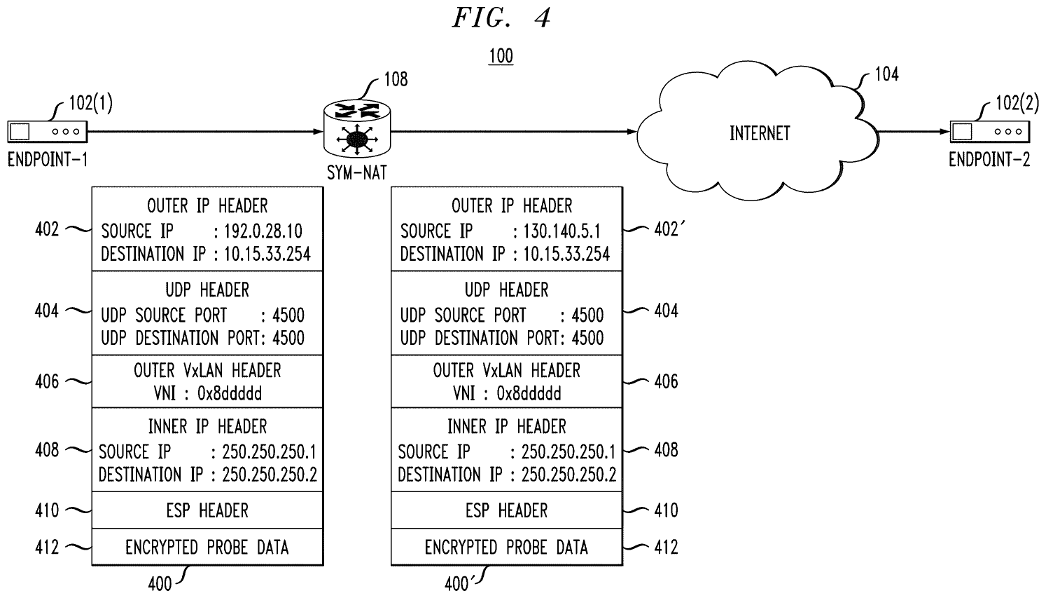

FIG. 4 is a block diagram illustrating the transmission of a special, encrypted, one-way, UDP probe packet from endpoint 102(1) to endpoint 102(2) of FIG. 1. The Perfd generator at endpoint 102(1) generates probe data with attributes such as source and destination uplink information, endpoint identifier, sequence number, etc. The probe data is then ESP encrypted, and the Inner IP headers are then added based on the local and remote endpoint identifiers, followed by Outer VxLAN encapsulation, the addition of UDP headers, and lastly the addition of the Outer IP headers. The Final probe packet 400 at endpoint 102(1) contains Outer IP Header 402, UDP Header 404, ESP Header 410, and Encrypted Probe Data 412, which are analogous to the corresponding fields in probe packet 300 of FIG. 3. As shown in FIG. 4, the source address in the Outer IP Header 402 of probe packet 400 is endpoint 102(1)'s private IP address (192.0.28.10).

As shown in FIG. 4, in addition to the fields that are analogous to the fields in prior-art probe packet 300 of FIG. 3, probe packet 400 also contains Outer VxLAN Header 406 and Inner IP Header 408 containing endpoint 102(1)'s ID (250.250.250.1) and endpoint 102(2)'s ID (250.250.250.2). The payload of probe packet 400 is ESP-encrypted using the Transport-mode tunnels created with the local and remote endpoint identifiers to generate the Encrypted Probe Data 412. In addition, the ESP Header 410 and the Encrypted Probe Data 412 are encapsulated along with the Inner IP Header 408 using Virtual Extensible Local Area Network (VxLAN) encapsulation.

As shown in FIG. 4, probe packet 400 traverses the uplink from endpoint 102(1) to Sym-NAT node 108, which uses the destination address (10.15.33.254) to identify probe packet 400 as an endpoint packet and therefore translates the packet's source address from endpoint 102(1)'s private IP address (192.0.28.10) to public IP address for endpoint packets (130.104.5.1), thereby creating modified Outer IP Header 402′ of modified probe packet 400′, which gets routed through the Internet 104 to endpoint 102(2). In this way, the probe packet creates a hole punch through the Sym-NAT node 108. Hole punching is a way to create/maintain a session in a NAT device. Since a NAT device is an independent entity, it is necessary to make the NAT device aware of the endpoints behind it. In that case, when a remote endpoint sends traffic to a local endpoint (before the local endpoint sends traffic to the remote endpoint), the NAT device will have the active NAT mappings to perform reverse NAT translation (public to private IP/Port conversion) and forward the packet to the local endpoint.

When probe packet 400′ arrives at endpoint 102(2), endpoint 102(2) (i) uses the source ID (250.250.250.1) in the packet's Inner IP Header 408 and the uplink information in the decrypted probe data 412 to identify endpoint 102(1) as the source of probe packet 400′ and (ii) updates the corresponding Probe-learnt field in its NAT-Traversal table accordingly. In particular, upon receiving probe packet 400′, endpoint 102(2) copies the source IP address and port (NAT public IP and port) to the packet metadata. Probe packet 400′ undergoes outer VxLAN decapsulation, IPsec decryption, and inner VxLAN decapsulation and finally updates the outer public IP address and port mapping in the packet payload. The SA lookup for decrypting the packet is based on Inner IP header. The Perfd analyzer at endpoint 102(2) processes this payload and updates endpoint 102(1)'s public IP addresses and port details in the Probe-learnt section of endpoint 102(2)'s NAT-Traversal table.

In a similar manner, endpoint 102(1) transmits an analogous special probe packet to endpoint 102(3) and endpoints 102(2) and 102(3) transmit analogous special probe packets to newly added endpoint 102(1).

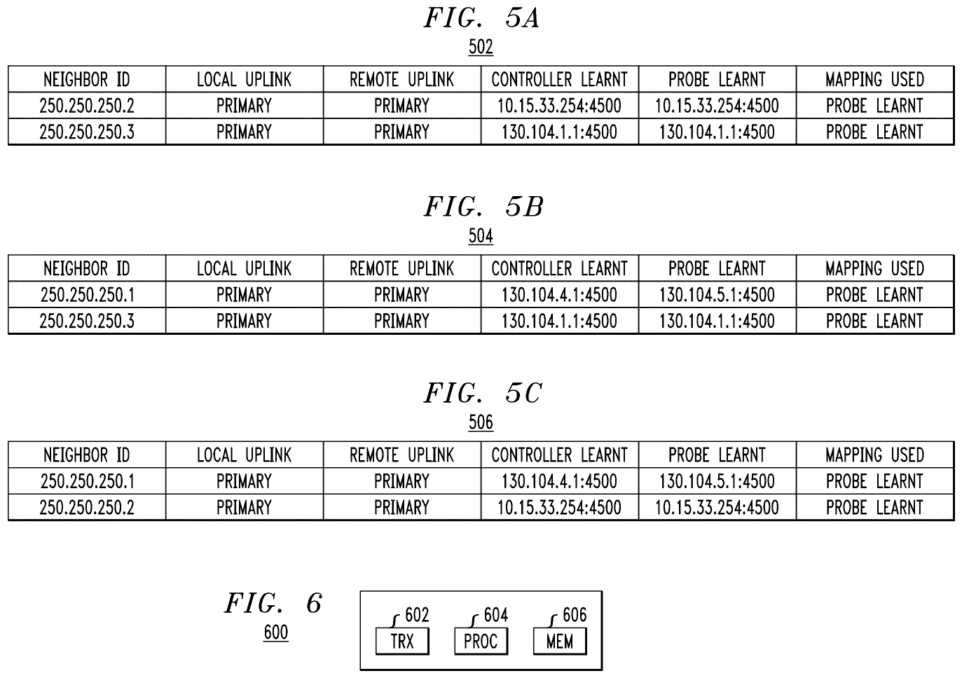

FIGS. 5A-5C represent the updated NAT-Traversal tables 502, 504, and 506 at endpoints 102(1)-102(3) after the special probe packets have been transmitted and processed. As shown, the NAT-Traversal tables 502, 504, and 506 now contain the probe-learnt information as well as the original controller-learnt information. Using the newly acquired probe-learnt information, endpoints 102(2) and 102(3) update their IPsec tunnels with endpoint 102(1). In particular, the IPsec tunnel at endpoint 102(2) for endpoint 102(1) will be updated from:
Endpoint 102(2) (10.15.33.254:4500)-Endpoint 102(1) (130.104.4.1:4500) to:
Endpoint 102(2) (10.15.33.254:4500)-Endpoint 102(1) (130.104.5.1:4500).

Likewise, the IPsec tunnel at endpoint 102(3) for endpoint 102(1) will be updated from:
Endpoint 102(3) (192.0.9.10:4500)-Endpoint 102(1) (130.104.4.1:4500) to:
Endpoint 102(3) (192.0.9.10:4500)-Endpoint 102(1) (130.104.5.1:4500).

As such, endpoints 102(2) and 102(3) will now be able to recognize incoming packets received from endpoint 102(1), and endpoints 102(2) and 102(3) will now be able to generate and send their own outgoing packets to endpoint 102(1).

FIG. 6 is a simplified hardware block diagram of an example node 600 that can be used to implement any of the elements 102, 106, 108, and 110 of FIG. 1. As shown in FIG. 6, the node 600 includes (i) communication hardware (e.g., wireless, wireline, and/or optical transceivers (TRX)) 602 that supports communications with other nodes, (ii) one or more processors (e.g., CPU and/or GPU microprocessors) 604 that control the operations of the node 600 and/or process data within the node 600, and (iii) one or more memories (e.g., RAM, ROM) 606 that store code executed by the processors 604 and/or data generated and/or received by the node 600.

In certain embodiments, the present disclosure is a method for an enterprise's local endpoint located behind a Symmetric Network Address Translation (Sym-NAT) node, the local endpoint having an identifier (ID), a private Internet Protocol (IP) address, a public IP address for controller packets, and a different public IP address for endpoint packets. The method comprises the local endpoint (a) generating a probe packet having (i) an outer IP header comprising the local endpoint's private IP address as the outer IP header's source address and (ii) an inner IP header comprising the local endpoint's ID as the inner IP header's source address and (b) transmitting the probe packet towards a remote endpoint of the enterprise.

In at least some of the above embodiments, the Sym-NAT node will modify the probe packet by translating the local endpoint's private IP address in the outer IP header into the public IP address for endpoint packets; and the remote endpoint will use the local endpoint's ID in the modified probe packet's inner IP header and uplink information in decrypted probe data to identify the source address in the modified probe packet's outer IP header as the local endpoint's public IP address for endpoint packets.

In at least some of the above embodiments, the probe packet is encrypted; and the local endpoint generates the encrypted probe packet by (i) encrypting the probe packet's payload and (ii) encapsulating the encrypted payload and the inner IP header.

In at least some of the above embodiments, the local endpoint (i) encrypts the probe packet's payload using Encapsulating Security Payload (ESP) encryption and (ii) encapsulates the encrypted payload and the inner IP header using Virtual Extensible Local Area Network (VxLAN) encapsulation.

In certain other embodiments, the present disclosure is a method for an enterprise's remote endpoint. The remote endpoint receives a probe packet from a local endpoint of the enterprise, wherein the local endpoint is located behind a Sym-NAT node, the local endpoint having an ID, a private IP address, a public IP address for controller packets, and a different public IP address for endpoint packets. The probe packet has (i) an outer IP header comprising the local endpoint's public IP address for endpoint packets as the outer IP header's source address and (ii) an inner IP header comprising the local endpoint's ID as the inner IP header's source address. The remote endpoint uses the local endpoint's ID in the probe packet's inner IP header and uplink information in decrypted probe data to identify the source address in the probe packet's outer IP header as the local endpoint's public IP address for endpoint packets.

In at least some of the above embodiments, the probe packet is encrypted; and the remote endpoint decrypts the encrypted probe packet.

In at least some of the above embodiments, the probe packet's payload is encrypted using ESP encryption; the probe packet's encrypted payload and the inner IP header are encapsulated using VxLAN encapsulation; and the remote endpoint de-encapsulates and decrypts the probe packet.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure. For example, a relatively thin layer of adhesive or other suitable binder can be used to implement such “direct attachment” of the two corresponding components in such physical structure.

As used herein in reference to an element and a standard, the terms “compatible” and “conform” mean that the element communicates with other elements in a manner wholly or partially specified by the standard, and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: —-only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A method for an enterprise's local endpoint located behind a Symmetric Network Address Translation (Sym-NAT) node, the local endpoint having an identifier (ID), a private Internet Protocol (IP) address, a public IP address for controller packets, and a different public IP address for endpoint packets, the method comprising the local endpoint:
generating a probe packet having (i) an outer IP header comprising the local endpoint's private IP address as the outer IP header's source address and (ii) an inner IP header comprising the local endpoint's ID as the inner IP header's source address; and
transmitting the probe packet towards a remote endpoint of the enterprise.

2. The method of claim 1, wherein:
the Sym-NAT node will modify the probe packet by translating the local endpoint's private IP address in the outer IP header into the public IP address for endpoint packets; and
the remote endpoint will use the local endpoint's ID in the modified probe packet's inner IP header and uplink information from decrypted probe data to identify the source address in the modified probe packet's outer IP header as the local endpoint's public IP address for endpoint packets.

3. The method of claim 1, wherein:
the probe packet is encrypted; and
the local endpoint generates the encrypted probe packet by (i) encrypting the probe packet's payload and (ii) encapsulating the encrypted payload and the inner IP header.

4. The method of claim 3, wherein the local endpoint:
encrypts the probe packet's payload using Encapsulating Security Payload (ESP) encryption; and
encapsulates the encrypted payload and the inner IP header using Virtual Extensible Local Area Network (VxLAN) encapsulation.

5. An enterprise's local endpoint located behind a Sym-NAT node, the local endpoint having an ID, a private IP address, a public IP address for controller packets, and a different public IP address for endpoint packets, the local endpoint comprising:
at least one processor; and
at least one memory storing instructions that, upon being executed by the at least one processor, cause the local endpoint at least to:
generate a probe packet having (i) an outer IP header comprising the local endpoint's private IP address as the outer IP header's source address and (ii) an inner IP header comprising the local endpoint's ID as the inner IP header's source address; and
transmit the probe packet towards a remote endpoint of the enterprise.

6. The local endpoint of claim 5, wherein:
the Sym-NAT node will modify the probe packet by translating the local endpoint's private IP address in the outer IP header into the public IP address for endpoint packets; and
the remote endpoint will use the local endpoint's ID in the modified probe packet's inner IP header and uplink information from decrypted probe data to identify the source address in the modified probe packet's outer IP header as the local endpoint's public IP address for endpoint packets.

7. The local endpoint of claim 5, wherein:
the probe packet is encrypted; and
the local endpoint is adapted to generate the encrypted probe packet by (i) encrypting the probe packet's payload and (ii) encapsulating the encrypted payload and the inner IP header.

8. The local endpoint of claim 7, wherein the local endpoint is adapted to:
encrypt the probe packet's payload using ESP encryption; and
encapsulate the encrypted payload and the inner IP header using VxLAN encapsulation.

9. A method for an enterprise's remote endpoint, the method comprising the remote endpoint:
receiving a probe packet from a local endpoint of the enterprise, wherein:
the local endpoint is located behind a Sym-NAT node, the local endpoint having an ID, a private IP address, a public IP address for controller packets, and a different public IP address for endpoint packets; and
the probe packet having (i) an outer IP header comprising the local endpoint's public IP address for endpoint packets as the outer IP header's source address and (ii) an inner IP header comprising the local endpoint's ID as the inner IP header's source address; and
using the local endpoint's ID in the probe packet's inner IP header to identify the source address in the probe packet's outer IP header as the local endpoint's public IP address for endpoint packets.

10. The method of claim 9, wherein:
the probe packet is encrypted; and
the remote endpoint decrypts the encrypted probe packet.

11. The method of claim 10, wherein:
the probe packet's payload is encrypted using ESP encryption;
the probe packet's encrypted payload and the inner IP header are encapsulated using VxLAN encapsulation; and
the remote endpoint de-encapsulates and decrypts the probe packet.

12. An enterprise's remote endpoint, the local endpoint comprising:
at least one processor; and
at least one memory storing instructions that, upon being executed by the at least one processor, cause the local endpoint at least to:
receive a probe packet from a local endpoint of the enterprise, wherein:
the local endpoint is located behind a Sym-NAT node, the local endpoint having an ID, a private IP address, a public IP address for controller packets, and a different public IP address for endpoint packets; and
the probe packet having (i) an outer IP header comprising the local endpoint's public IP address for endpoint packets as the outer IP header's source address and (ii) an inner IP header comprising the local endpoint's ID as the inner IP header's source address; and
use the local endpoint's ID in the probe packet's inner IP header and uplink information from decrypted probe data to identify the source address in the probe packet's outer IP header as the local endpoint's public IP address for endpoint packets.

13. The remote endpoint of claim 12, wherein:
the probe packet is encrypted; and
the remote endpoint is adapted to decrypt the encrypted probe packet.

14. The remote endpoint of claim 13, wherein:
the probe packet's payload is encrypted using ESP encryption;
the probe packet's encrypted payload and the inner IP header are encapsulated using VxLAN encapsulation; and
the remote endpoint is adapted to de-encapsulate and decrypt the probe packet.
